(19) United States
(12) Patent Application Publication
(10) Pub. No.: US 2017/0280941 A1
(43) Pub. Date: Oct. 5, 2017

(54) ANTI-SLIP MAT

(71) Applicant: Chun-Fu KUO, Taichung City (TW)

(72) Inventor: Chun-Fu KUO, Taichung City (TW)

(21) Appl. No.: 15/629,080

(22) Filed: Jun. 21, 2017

Related U.S. Application Data
(63) Continuation-in-part of application No. 14/872,710, filed on Oct. 1, 2015.
Application No. 14/872,710 is a continuation-in-part of application No. 14/485,635, filed on Sep. 12, 2014, now abandoned.

(51) Int. Cl. A47K 3/00; A47G 27/02; B32B 5/06; B32B 3/26; B32B 5/02

(52) U.S. Cl. CPC A47K 3/002; B32B 3/266; B32B 5/028; B32B 5/06; A47G 27/02; B32B 2262/0276; B32B 2309/105; B32B 2471/04

(57) ABSTRACT

The anti-slip mat includes a covering layer and a structural layer. The covering layer is formed with a plurality of apertures. The structural layer has a predetermined thickness and has a plurality of through holes extending vertically. The covering layer is disposed on a top face of the structural layer. The apertures communicate the through holes. The structural layer is weaved by a water-proofing fiber to form a three-dimensional structure. Each aperture has an internal diameter smaller than an internal diameter of each through hole.

This application is a Continuation-In-Part of prior application Ser. No. 14/872,710, filed Oct. 1, 2015, which is a Continuation-In-Part of prior application Ser. No. 14/485,635 filed Sep. 12, 2014, the entire contents of which are hereby incorporated by reference.

### BACKGROUND OF THE INVENTION

### Field of the Invention

### Description of the Prior Art

Anti-slip mat is used in various situations, such as kitchen or bathroom. In the bathroom, the anti-slip mat is usually placed in the bathtub for the user standing to take a shower.

Some anti-slip mats don't allow the water flow therethrough. Thus, the mat may be ponding to result further slipping. Some other anti-slip mats have through holes for draining. However, if the through holes are too small, water is drained slowly. On the contrary, if the through holes are too big, dander and dirt may pass through the through hole.

To solve this problem, an improved anti-slip mat is provided. The through hole of the mat has a smaller diameter at the upper portion and a larger diameter at the lower portion. Thus, water is drained fast, and dander and dirt may not enter the through holes. However, the mat is usually weaved as a single piece, so the through hole is difficult to form.

Besides, for support, the fiber of the mat has to be hard enough. However, the hard fiber is uncomfortable for stepping on.

### SUMMARY OF THE INVENTION

The main object of the present invention is to provide an anti-slip mat which is able to prevent from ponding and is easy to manufacture.

To achieve the above and other objects, an anti-slip mat of the present invention includes a covering layer and a structural layer. The covering layer is formed with a plurality of apertures. The structural layer has a predetermined thickness and has a plurality of through holes extending vertically. The covering layer is disposed on a top face of the structural layer. The apertures communicate the through holes. The structural layer is weaved by a water-proofing fiber to form a three-dimensional structure. Each aperture has an internal diameter smaller than an internal diameter of each through hole.

Thereby, the anti-slip mat can prevent from ponding, and is easy to manufacture.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a profile of the present invention;

FIG. 4 is a partial enlargement of FIG. 3;

FIG. 5 is an illustration of the present invention.

### DETAILED DESCRIPTION OF THE PREFERRED EMBODIMENTS

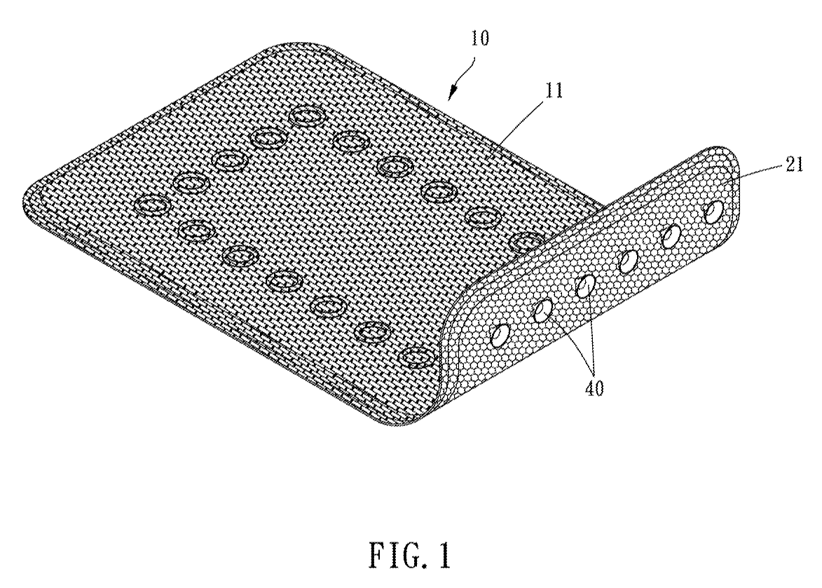

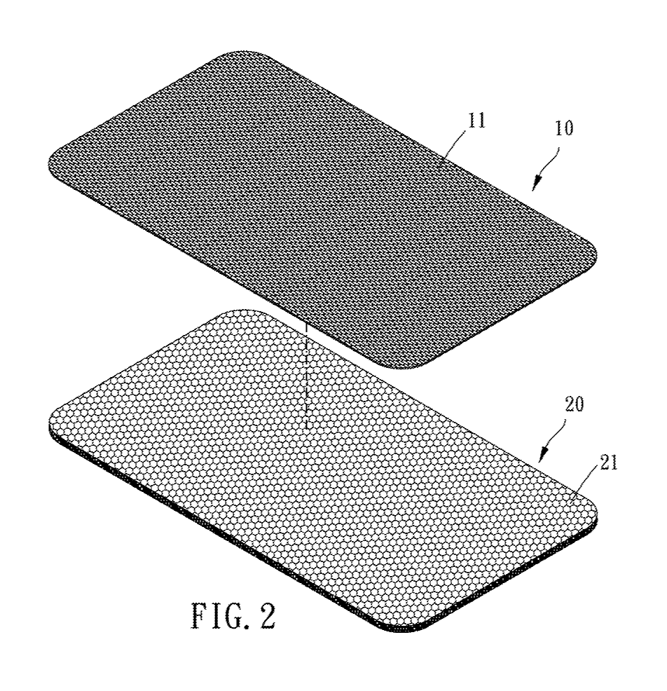

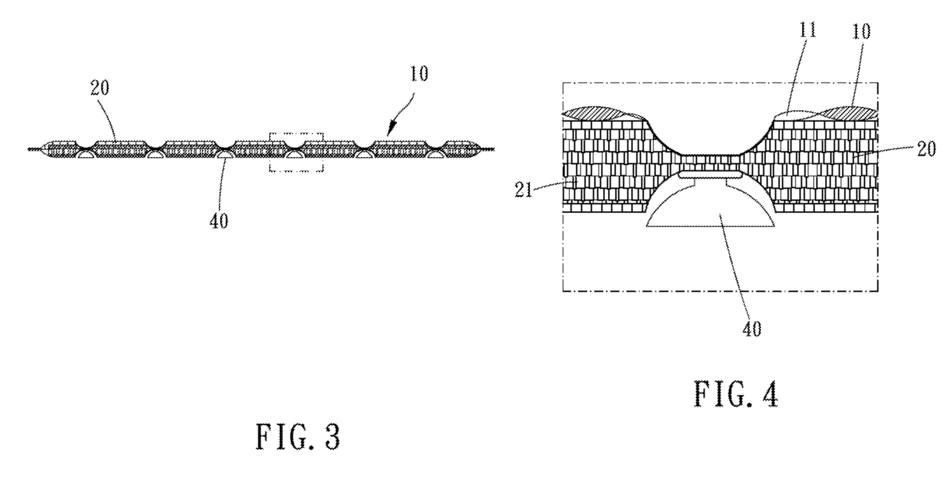

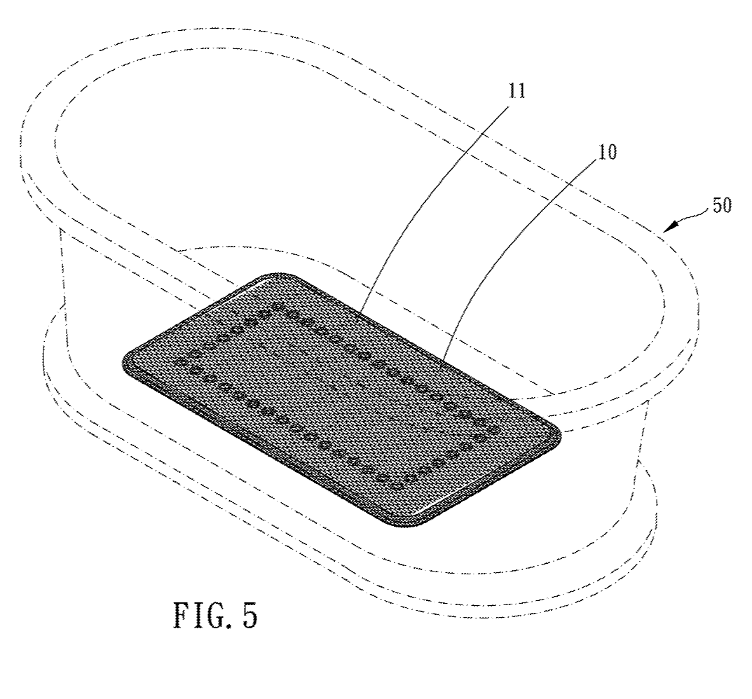

Please refer to FIG. 1 to FIG. 3 for a first embodiment of the present invention. The anti-slip mat of the present embodiment includes a covering layer 10 and a structural layer 20. The covering layer 10 is covered by a foamed covering agent and forms a plurality of apertures 11. The structural layer 20 has a predetermined thickness and has a plurality of through holes 21 extending vertically. The covering layer 10 is disposed on the top face of the structural layer 20. The through holes 21 communicate the apertures 11. The structural layer 20 is weaved by a water-proofing fiber to form a three-dimensional structure. The internal diameter of each aperture 11 is smaller than the internal diameter of each through hole 21.

More specifically, the covering agent is selected from synthetic resin, PVC, silicone, TPR, and PU. The covering layer 10 is a fabric mesh, and the fabric mesh forms the apertures 11. Preferably, the fabric mesh is made by polyester fiber.

In the present embodiment, the structural layer 20 is covered by a covering agent at least at the bottom thereof The covering agent is selected from synthetic resin, PVC, silicone, TPR, and PU. Preferably, the whole structural layer 20 is covered by the covering agent for water-proof, anti-slip, and increasing the density.

The covering layer 10 and the structural layer 20 can be engaged by various means. For example, the fringes of the covering layer 10 and the structural layer 20 are engaged by sewing, adhesive agent, or melting. In some possible embodiments, the covering layer is adhered onto the structural layer before the covering agent is dried. In other possible embodiments, the covering layer and the structural layer can be engaged by at least one positioning element.

In the present embodiment, the internal diameter of each aperture 11 is ranged from 0.1 cm to 1 cm, and the thickness of the structural layer 20 is ranged from 0.5 cm to 1.5 cm. The thickness of the covering layer 10 is smaller than the thickness of the structural layer 20. The density of the covering layer 10 is larger than 1 g/cm³. The density of the structural layer 20 is also larger than 1 g/cm3. Besides, at least part of the apertures 11 and the through holes 21 are non-coaxially arranged. Specifically, the aperture 11 is smaller than the through hole 21, and the number of the apertures 11 is larger than the number of the through holes 21. Thus, part of the apertures 11 and the through holes 21 are non-coaxially arranged.

That is, the fabric mesh is independent from the structural layer, so desired fabric mesh and structural layer can be chosen to combine.

In use, the bottom of the structural layer 20 can be disposed with adhesive members 40, such as suction pads. The suction pads are positioned onto the structural layer by heating. The adhesive members can prevent the mat from slipping when used in the bathtub 50 or on the floor of bathroom. In addition, the mat may not pond, and the covering layer can block dander or dirt to make it easier to clean. Besides, the two-layer mat is easier to manufacture.

In conclusion, the present invention has the following advantages.
1. Drain fast, prevent from ponding, easier to clean.
2. Easier to manufacture.
3. Covering layer and structural layer can made by different material and have different structure for different purpose.
4. The aperture can be quite smaller than the through hole because the covering layer and the structural layer are manufactured separately.

What is claimed is:

1. An anti-slip mat, including a covering layer and a structural layer, the covering layer being formed with a plurality of apertures, the structural layer having a predetermined thickness and having a plurality of through holes extending vertically, the covering layer being disposed on a top face of the structural layer, the apertures communicating the through holes;
wherein the structural layer is weaved by a water-proofing fiber to form a three-dimensional structure;
wherein each aperture has an internal diameter smaller than an internal diameter of each through hole.

2. The anti-slip mat of claim 1, wherein the covering layer is a fabric mesh, the fabric mesh forms said apertures.

3. The anti-slip mat of claim 2, wherein the fabric mesh is made by polyester fiber.

4. The anti-slip mat of claim 3, wherein the covering layer is covered by a foamed covering agent, the covering agent is selected from a group composed of synthetic resin, PVC, silicone, TPR, and PU.

5. The anti-slip mat of claim 1, wherein the structural layer is covered by a covering agent at least at a bottom portion thereof

6. The anti-slip mat of claim 5, wherein the covering layer is covered by a foamed covering agent, the covering agent is selected from a group composed of synthetic resin, PVC, silicone, TPR, and PU.

7. The anti-slip mat of claim 1, wherein a fringe of the covering layer and a fringe of the structural layer are engaged by sewing.

8. The anti-slip mat of claim 1, wherein the covering layer is engaged with the top face of the structural layer by an adhesive agent.

9. The anti-slip mat of claim 1, wherein the covering layer and the structural layer are fixed together by at least one positioning element.

10. The anti-slip mat of claim 1, wherein the internal diameter of each aperture is ranged from 0.1 cm to 1 cm.

11. The anti-slip mat of claim 1, wherein the thickness of the structural layer is ranged from 0.5 cm to 1.5 cm, a thickness of the covering layer is smaller than the thickness of the structural layer.
